(19) United States
(12) Patent Application Publication
(10) Pub. No.: US 2015/0276936 A1
(43) Pub. Date: Oct. 1, 2015

(54) CASCADED COUPLED POSITIONING SYSTEM

(71) Applicant: Caterpillar Inc., Peoria, IL (US)

(72) Inventors: Paul R. Friend, Morton, IL (US); Eric A Reiners, Washington, IL (US)

(73) Assignee: Caterpillar Inc., Peoria, IL (US)

(21) Appl. No.: 14/230,716

(22) Filed: Mar. 31, 2014

(51) Int. Cl. G01S 19/47

(52) U.S. Cl. CPC G01S 19/47

(57) ABSTRACT

A cascaded coupled positioning system is provided for acquiring a position of a vehicle. In the current disclosure, a global navigation satellite system is coupled with a first inertial measurement unit. The global navigation satellite system is coupled with the first inertial measurement unit by using a first signal processing unit configured to provide a tightly coupled positioning solution. The tightly coupled positioning solution of the first signal processing unit is integrated with a second inertial measurement unit. The integration is performed using a second signal processing unit configured to provide a loosely coupled positioning solution.

### TECHNICAL FIELD

The present disclosure generally relates to a vehicle positioning system. More specifically, the present disclosure relates to a cascaded coupled vehicle positioning system using a tightly coupled solution and a loosely coupled solution to position a vehicle.

### BACKGROUND

Various vehicles in the automobile industry may be equipped with a global navigation satellite system. The global navigation satellite system may enable an operator of a vehicle to acquire the position data of the vehicle at a given instance of time. The global navigation satellite system acquires the position data based on the signals received from one or more satellites orbiting around the earth. The global navigation satellite system may fail to receive the signals, in a situation when a vehicle may be, but not limited to, travelling in a tunnel. To counter such scenarios, an additional system is provided to aid the global navigation satellite system. In existing vehicles, a coupled positioning system may be used for reliable navigation. The coupled positioning system may include the global navigation satellite system and an inertial measurement unit electronically coupled together. The coupled positioning system may be suitable for use in high jamming and highly dynamic environments. Two well-known methods of coupling the global navigation satellite system and the inertial measurement unit include a tightly coupled positioning solution and a loosely coupled positioning solution.

The tightly coupled positioning solution utilizes the global navigation satellite system and the inertial measurement unit together in order to aid in solving global navigation satellite system pseudo ranges. This allows the global navigation satellite system to perform better for short periods of time, when fewer than the required number of satellite signals are being received. The loosely coupled positioning solution utilizes the global navigation satellite system as a separate input, and does not return information to assist in determining the pseudo ranges. The tightly coupled positioning solution has marginal benefits over the loosely coupled positioning solution. However, the benefits may not outweigh the extra complexity and cost that is required for the tightly positioning coupled solution.

### SUMMARY

In an embodiment, a cascaded coupled vehicle positioning system is disclosed. The cascaded coupled vehicle positioning system comprises a global navigation satellite system, a first inertial measurement unit, a first signal processing unit, a second inertial measurement unit, and a second signal processing unit. The global navigation satellite system may be configured to generate a position signal corresponding to a vehicle. The first inertial measurement unit may be configured to collect a first information associated with a vehicle. The first signal processing unit may be configured to generate a first positioning data associated with the vehicle. The first positioning data may be based on the position signal and the first information. The first signal processing unit provides a tightly coupled positioning solution. The second inertial measurement unit may be configured to collect a second information associated with the vehicle. The second inertial measurement unit may have a higher accuracy than the first inertial measurement unit. The second signal processing unit may be configured to generate a second positioning data associated with the vehicle. The second positioning data may be based on the first positioning data and the second information. The second signal processing unit provides a loosely coupled positioning solution.

Other features and advantages of the disclosure will become apparent to those skilled in the art, upon review of the following detailed description and drawings.

### BRIEF DESCRIPTION OF THE DRAWINGS

FIG. 1 is a block diagram illustrating architecture of a cascaded coupled vehicle positioning system, in accordance to the concepts of the present disclosure.

### DETAILED DESCRIPTION

Detailed embodiments of the present disclosure are described herein with reference to the following figure. The specific structural and functional details disclosed herein are intended to be exemplary and should not be interpreted as limiting the disclosure.

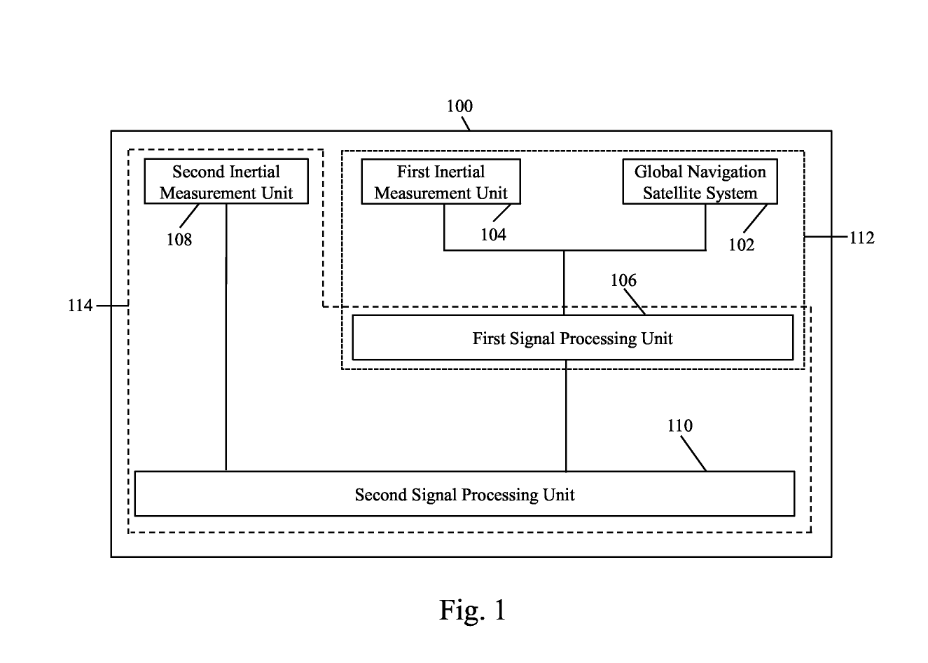

FIG. 1 is a block diagram illustrating architecture of a cascaded coupled vehicle positioning system 100, in accordance to the concepts of the present disclosure. The cascaded coupled vehicle positioning system 100 may include a global navigation satellite system 102, a first inertial measurement unit 104, a first signal processing unit 106, a second inertial measurement unit 108, and a second signal processing unit 110.

The global navigation satellite system 102 (hereinafter referred to as GNSS 102) may be configured to provide a position signal for any geographical location in the world. Examples of the GNSS 102 currently in operation include, but are not limited to, the United States' Global Positioning System (GPS), the Russian Federation's Global Orbiting Navigation Satellite System (GLONASS), and Europe's Galileo.

The first inertial measurement unit 104 (hereinafter referred to as IMU1 104) and GNSS are two separate units integrated together communication with each other. The IMU1 104 may be configured to collect a first information associated with the vehicle. The first information collected may pertain to, but not limited to velocity, an orientation, gravitational force, and an acceleration associated with the vehicle. In an embodiment, the IMU1 104 is universal in nature and is not vehicle specific. This implies that the configuration, the design, the assembly, the components, the working and the like for the IMU1 104 are not affected by the type of the vehicle.

In an embodiment, the IMU1 104 may include a first sensor and a second sensor. The first sensor may be an accelerometer triad. The second sensor may be an angular rate sensor triad. The accelerometer triad may generate three analog signals describing the accelerations along each of its axes produced by, and acting upon, the vehicle. The angular rate sensor triad may generate three analog signals. The three analog signals describe the vehicle's angular rate about each of three axes. However, it will be evident to a person with ordinary skills in the art, that this embodiment is exemplary and does not limit the disclosure.

The first signal processing unit 106 may be configured to receive the position signal from the GNSS 102 and the first information from the IMU1 104. The first signal processing unit 106 may be further configured to provide a tightly coupled positioning solution 112. In general, a tightly coupled system connects together information from multiple sources to obtain a precise output. The tightly coupled solution achieves the precise output by providing a continuous feedback to the multiple sources based on the difference in the output, thus reducing the error after each cycle. Hence, achieving the precise output. For example, in a tightly coupled system, a processor may receive data from two sources and may iteratively use the date from the two sources to determine a more precise output.

In an embodiment, the first signal processing unit 106 may be a microprocessor. The microprocessor works on the principal of linear quadratic estimation. The linear quadratic estimation is commonly known as kalman filter. The kalman filter is an algorithm that uses a series of measurements observed over time, containing random variations and other inaccuracies, and produces estimates of unknown variables that tend to be more precise than those based on a single measurement alone. Hence, the first signal processing unit 106, uses an input from GNSS 102 and IMU1 104 to provide a precise measurement in a tightly coupled positioning solution 112 as a first positioning data.

The second inertial measurement unit 108 (herein after referred to as IMU2 108) may be configured to collect a second information associated with the vehicle. In an embodiment, the IMU2 108 is similar to IMU1 104 in terms of architecture and functionality. However, the IMU2 108 may include sensors, which have higher accuracy and precision than the sensors of IMU1 104. This may result in higher cost of IMU2 108 than IMU1 104. In an embodiment, the IMU2 108 is vehicle specific in nature. This implies that the configuration, the design, the assembly, the components, the working and the like for the IMU2 108 are dependent on the type of the vehicle; the IMU2 108 is used with.

The second signal processing unit 110 may be configured to receive the first positioning data from the first signal processing unit 106, and the second information from the IMU2 108. The second signal processing unit 110 may be further configured to provide a loosely coupled positioning solution 114. In general a loosely coupled system processes the information from the multiple sources to obtain an output. The achieved output is not analyzed for any existing errors and hence there is no feedback. In an embodiment, the second signal processing unit 110 may be an integration filter. The integration filter may include a processor and a data storage. The processor may be a general-purpose processor, a digital signal processor, a microcontroller, etc. The processor may include an execution unit, storage, instruction decoding, peripherals, input/output systems and various other components and sub systems. The second signal processing unit 110 may receive an input from the first signal processing unit 106 and the IMU2 108 and may provide the loosely coupled positioning solution 114 by processing information from the first signal processing unit 106 and the IMU2 108 separately. The second signal processing unit 110 while processing the information from the first signal processing unit 106 will only consider the information from IMU2 108 and vice-versa. The second signal processing unit 110 provides a second positioning data in the form of loosely coupled positioning solution 114.

### INDUSTRIAL APPLICABILITY

In operation, the GNSS 102 may provide the position signal associated with the vehicle. Running in parallel, the IMU1 104 and the IMU2 108 may collect information associated with the vehicle. The position signal from the GNSS 102 and the first information collected by the IMU1 104 may then be transferred to the first signal processing unit 106.

The first signal processing unit 106 receives the position signal from the GNSS 102 and the first information from the IMU1 104. The first signal processing unit 106 may then processes the GNSS 102 pseudo-range, delta range, and carrier-phase, based on the position signal received from the GNSS 102 and the angular rate and acceleration based on the first information received from the IMU1 104. Further, the first signal processing unit 106 may provide a feedback to the IMU1 104. The preceding process may provide the tightly coupled positioning solution 112 as the first positioning data for the cascaded coupled vehicle positioning system 100.

The first positioning data may then be transferred to the second signal processing unit 110, along with the second information from the IMU2 108. The second signal processing unit 110 may be configured to act as an integrator. The second signal processing unit 110 may combine the first positioning data with the second information from IMU2 108, to provide the loosely coupled positioning solution 114. In an embodiment, the second signal processing unit 110 may receive the first positioning data from the first signal processing unit 106 in the form of the tightly coupled positioning solution 112 and may track an error in the second information obtained from the IMU2 108. In an embodiment, when the radio frequency signals are unreliable and/or unavailable to GNSS 102, the first positioning data from the first signal processing unit 106 may be completely ignored and unused. To function in this way, the second information from the IMU2 108 may be processed by the second signal processing unit 110. The second signal processing unit 110 may merge or combine the first positioning data from the first signal processing unit 106 with the second information from IMU2 108. This may remove the errors in the second information caused by biases from the IMU2 108. The results of this process may be the loosely coupled positioning solution 114 providing the second positioning as a final positioning data for cascaded coupled vehicle positioning system 100.

It may be desirable to have a cascaded coupled vehicle positioning system 100 that is reliable, accurate, compact, and cost efficient. The cascaded coupled vehicle positioning system 100 may be capable of operating in a high dynamic environment against a possibility of multi-type signal loss or deterioration in GNSS 102. The cascaded coupled vehicle positioning system 100 may include the GNSS 102, the IMU1 104, the first signal processing unit 106, the IMU2 108, and the second signal processing unit 110. The GNSS 102 may be configured to generate the position signal. The IMU1 104 and the IMU2 108 may work simultaneously with the GNSS 102. The IMU1 104 and the IMU2 108 may be configured to collect first information and the second information associated with the vehicle respectively. The position signal from the GNSS 102 and the first information from the IMU1 104 may be transferred to the first signal processing unit 106. The first signal processing unit 106 may be configured to process the position signal along with the first information from the IMU1 104 and may provide the tightly coupled positioning solution 112 as the first positioning data. The first positioning data from the first signal processing unit 106 may then be transferred to the second signal processing unit 110. The second information from IMU2 108 may also be transferred to the second signal processing unit 110. The second signal processing unit 110 may be configured to process the first positioning data along with the second information from the IMU2 108 and may provide the loosely coupled positioning solution 114. The loosely coupled positioning solution 114 from the second signal processing unit 110 is the second positioning data. The disclosure provides a cascaded coupled vehicle positioning system 100, with the benefits of the tightly coupled positioning solution 112, which may provide an easier integration of the loosely coupled positioning solution 114. In an embodiment, the GNSS 102 and the IMU1 104 may be installed in an antenna of the vehicle along with the first signal processing unit 106. It can be contemplated that cascading of multiple tightly coupled positioning solutions and loosely coupled positioning solutions is a possible based on this disclosure.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A cascaded coupled vehicle positioning system comprising:
a global navigation satellite system configured to generate a position signal corresponding to a vehicle;
a first inertial measurement unit configured to collect a first information associated with the vehicle;
a first signal processing unit configured to generate a first positioning data associated with the vehicle based on the position signal and the first information, wherein the first signal processing unit provides a tightly coupled positioning solution;
a second inertial measurement unit configured to collect a second information associated with the vehicle, wherein the second inertial measurement unit has a higher accuracy than the first inertial measurement unit; and
a second signal processing unit configured to generate a second positioning data associated with the vehicle based on the first positioning data and the second information, wherein the second signal processing unit provides a loosely coupled positioning solution.
